(19) United States
(12) Patent Application Publication
(10) Pub. No.: US 2004/0035699 A1
(43) Pub. Date: Feb. 26, 2004

(54) Method and fabrication of the potentiometric chemical sensor and biosensor based on an uninsulated solid material

(76) Inventors: Shen-Kan Hsiung, Taoyuan (TW); Jung Chuan Chou, Yunlin (TW); Tai-Ping Sun, Taoyuan (TW); Wen Yaw Chung, Taoyuan (TW); Yin Li-Te, Taipei (TW); Chung We Pan, Pingtung (TW)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 10/287,598

(22) Filed: Nov. 5, 2002

(30) Foreign Application Priority Data
Aug. 21, 2002 (TW) 091118850

(51) Int. Cl. G01N 27/333

(52) U.S. Cl. 204/419

(57) ABSTRACT

In this invention, a potentiometric electrochemical sensor and biosensor based on an uninsulated solid-state material was presented.

This potentiometric electrochemical sensor and biosensor is different from the traditional ion sensitive field effect transistor (ISFET), which the sensing electrode was separated from the field effect transistor and was only connected to the field effect transistor by a metal line. Therefore the sensing electrode can be seen as a low cost disposable electrode. The sensing structure of this sensor is more rigid than the glass electrode, and the fabricative cost is lower than those of glass electrode and traditional ISFET electrode. In addition, this device shows a linear pH sensitivity of approximately 5860 mV/pH with the high correlation coefficient up to 0.999 in a concentration range between pH2 and pH12. Therefore this device owns a high and linear sensitivity. In addition, this device will not be affected by light interference.

Based on the above characteristics, a disposal-sensing device can be achieved. Thus, this invention has a high feasibility in the electrochemical sensor and biosensor.

### SUMMARY OF THE INVENTION

### INTRODUCTION

In this invention, an electrochemical potential sensor and a biosensor, based on an uninsulated solid-state material, are presented.

Electrochemical potential sensors and biosensors with this base are different from the traditional ion sensitive field effect transistor (ISFET), in that the sensing electrode of the new invention is separated from the field effect transistor, connecting to the field effect transistor by a mere metallic wire. Therefore the sensing electrode can be seen as a low cost, disposable electrode. Furthermore, the sensing structure of this sensor is more rigid than the commercial glass electrodes, and the cost is lower than those of the traditional ISFET and glass electrodes. In addition, this device shows a linear pH sensitivity of approximately 5860 mV/pH with a high correlation coefficient over 0.999 in the pH range of 2 to 12. Therefore, this device possesses a high, linear sensitivity. To add to the strength of this invention, light interference of its performance is minimal.

Based on the above characteristics, a disposable sensor can be achieved. Thus, this invention has a high feasibility and applicability in electrochemical sensors and biosensors.

### INDUSTRIAL APPLICABILITY

This invention illustrates the use of inorganic, non-insulated, solid state materials to create an electrochemical potential sensors and biosensors in a solid-state process.

### BACKGROUND

Glass electrodes have many merits such as high linearity, good ion distinction, and stability. However, problems like the large size, high cost and long response time a reaction time have decreased their performance. In 1989 on pages 59-63, issue 1, volume 67 of the Int. J., B. D. Liu et al. illustrated the new direction in utilizing the mature field effect ion sensor developed by the mature silicon semiconductor integrated circuit process. The attempt was to replace the traditional glass electrode.

In 1970 on pages 70-71, volume BME-17 of IEEE Transactions Biomedical Engineering, Piet Bergveld first removed the metallic part of the poles of the metal-oxide-semiconductor field effect transistor (MOSFET). He then immerses the element into an aqueous solution; use the oxidation layer as an insulated ion sensor. This sensor produces different electrical potential at the interface when contacting solutions of different acidity, changing the electric current of the circuit to measure the pH or other ion concentration of the solution. Thus, Piet Bergveld named this sensor the ion sensitive field effect transistor (ISFET).

In the 70's, the development and application of the ISFET were still in an explorative stage. When the 80's arrived, the research on this field has reached a new dimension, whether in the basic theoretic research, key technologies, or practical applications. For example, dozens of ion and chemical field effect transistor based on the ISFET had been created, excelled in the microlization, modularization, and multi-function. The global popularity of the ISFET in a mere decade owed the credit from its distinctive characteristics described by D. Yu et al. in 1990 on pages 57-62, volume 1 of the Chemical Sensors,J. Sensor & Transducer Tech:

1. Minute size allowing micro solution measurements.

2. High input resistance and low output resistance.

3. Fast effect.

4. Compatible production process with the MOSFET technology.

Merits described above have fired a research fever on the ISFET within many research institutes in the past 2 decades. A brief outline of the international development of this element is noted below:

W. M. Siu and R. S. C. Cobbold reported an ISFET with silicon dioxide, silicon nitride, oxide, and aluminum oxide as ion sensors in 1979 on pages 1805 to 1815, issue 11, volume ED-26.

ISFET based on different elemental structures: such as back contact field effect ion sensor reported by A. S. Wong in his Ph.D. Thesis in Case Western Reserve University, 1985. Or the expanding ISFET reported by J. Van Der Spiegel et al. on pages 291-298, volume 4 of Sensors and Actuators B, 1983.

Microlization of the reference electrode reported by D. Yu on pages 53 to 57, volume 3 of Chemical Sensors, J. Sensor & Transducer Tech., 1991. Differential ISFET on pages 221 to 237, volume 11 of Sensors and Actuators, 1987.

On pages 237 to 239, volume 5 of Sensors and Actuators B, 1991, Atushi Saito reported the use of enzymes on the ISFET to detect metabolic messages in biology (for example: detection of glucose or oxygen level in the blood.) Theoretical research attachment bond module on pages 315 to 3 18 reported by L. K. Meixner on pages 315 to 318 on volume 6 of Sensors and Actuators B, 1992.

R. E. G. van Hal reported a study on wrapping materials on pages 17 to 26, volume 23 of Sensors and Actuators B, 1995. B. H. Van Der Schoot et al. reported an integration of measuring system and sensors on pages 239 to 241, volume 4 of Sensors and Actuators B, 1991.

M. Grattarola reported yet another study on the field effect ion sensor simulation on pages 813 to 819, issue 4, volume 39 of IEEE Transactions on Electron Devices, 1992.

Listed below are patents granted so far: U.S. Pat. No. 5,309,085 (May 3, 1994)—readout circuit as a biological ISFET. This circuit has a simple structure and easy integration. The circuit is composed of input terminals from two ISFET, one as an enzyme field effect transistor, the other as a reference field effect transistor. Immobilizing an enzyme to the electrode: of the ISFET does the enzyme field effect transistor. This circuit has different magnifying functions to magnify and output the ion detection. The voltage effect of the ISFET is due to the temperature effect of unstable reference electrodes. Thus the benefits of the circuit can be recognized and the sensor can be adjusted. This ion sensitive filed effect transistor-biosensor can be integrated on one single chip with the measuring circuit, to minimize the size of the sensor.

U.S. Pat. No. 5,296,122 (Mar. 22, 1994)—hydrophobic thin film used as the reference electrode of the ion sensitive field effect transistor. This hydrophobic thin film can grow on the substrate via neutral electrolyte or electroplating. The apparatus includes a vacuum, an atom ray generator, a base, a cover board to control growth elements. This thin film is applicable to ion sensors such as ion sensitive field effect transistors and enzyme sensors.

U.S. Pat. No. 5,061,976 (Oct. 29, 1991)—ion sensitive field effect transistor with carbon gate insulated electrode. Conducting material, 2,6 xylenol is then coated. The ion sensitive field effect transistor exhibits high sensitivity to hydrogen ions, low time drift, high stability, and low light effect. If other ion selective thin film or enzymes are further coated on the 2,6 xylenol, different ions and metabolites of different concentrations can be detected.

U.S. Pat. No. 6,218,208 (Apr. 17, 2001)—hot steam plating or ratio frequency sputtering is used to produce a field effect ion sensor with a metal light cover. The structure: tin oxide/metal/silicon oxide multi-structure sensor and tin oxide/metal/silicon nitride/silicon nitride multi-structure sensor. Many excellent characteristics are associated with this device, such as Nernst Effect between pH 2 to pH 10—high linearity in the 56˜58 mV/pH range. One unique point is that this sensor effectively decreased light interference. Moreover, this process requires simple apparatus, low cost, and easy mass production. Inexpensive, disposable sensors can also be produced. Therefore this invention possesses extremely high feasibility and applicability among the ISFET.

U.S. Pat. No. 5,925,318 (Jul. 20, 1999)—an iron-detecting sensor. Iron compounds such as lactoferrin are immobilized on the surface of the potentiometric or acidic sensor. Reactions changes the potential or the pH value of the iron-detecting sensor, therefore this sensor detects such changes. This patent includes iron molecule ion compound ion sensitive field effect transistor and acidity paper tester.

U.S. Pat. No. 5,918,110 (Jun. 29,1999)—this patent is on an multi-sensor including pressure and electrochemical sensor, based on the ion sensitive field effect transistor on a silicon substrate. A protective layer follows deposition of a nitride layer as an acidity sensor. Then a multi-silicon thin film is positioned on the top of the vacuum space. This area is the pressure sensor, and the readout of the sensor can be through the CMOS standard. The oxidized middle layer of the gaseous sensor is made by the removal of oxidized layer with the wet chemistry method. The platinum contact point and the attached protective layer are deposited by PECVD. The pressure sensor is made after the completion of the gaseous sensor layers.

U.S. Pat. No. 5,516,697 (May 14, 1996)—a simple, low-cost biosensor for detecting ion concentrations. Lactoferrin is immobilized on the sensor surface. Lactoferrin reacts with iron and expresses electricity, changing the electropotential or the surface potential of the acidic sensor. This property enables the biosensor to detect ion concentrations. The biosensor includes the ion sensitive field effect transistor, and acidity paper tester.

According to the current literature, there are some materials most frequently used as the sensing membrane of the pH sensor such as silicon dioxide, silicon nitride, Ta₂O₅, and aluminum oxide. Hung-Kwei Liao et al. reported the first-time completion of the ISFET with tin oxide as the sensing membrane in this laboratory on pages 410 to 415 of Proceedings of the 3^{rd} East Asian Conference on Chemical Sensors (Seoul,Korea), 1997. Properties of this sensor include Nernst Effect. Within the range of 56˜58 mV/pH, a high linearity, time stability, low drift, and a reaction speed of lower than 0.1 second were all achieved. This laboratory also developed a multi-layered sensor, deterring light interference: sensor film/metal/silicon dioxide multi-layer sensor and film layer/metal/silicon nitride/silicon dioxide multi-structured sensor. This light deterring structure has inspired the structure of the EGFET. This apparatus views the metallic light deterring layer as a potential, and is pulled out of the field effect transistor with a conductor line, connecting to an ion sensitive film. The ion sensitive film is thus completely separate from the field effect transistor, only connected through a wire. Therefore, the ion sensitive film part can be seen as a low-cost, disposable ion sensitive electrode or bio-electrode. The field effect transistor part can then seen as a reusable front readout circuit. Our laboratory has discovered that the traditional highly insulative inorganic sensitive materials such as silicon nitride, aluminum oxide and tallium oxide cannot be used in this apparatus. The reason is that high insulation results in higher capacitance effect and an extremely unstable Transient response. However, this EGFET measuring apparatus performs rather well with the non-insulation sensitive materials below:

tin oxide, ITO, titanium nitride. Therefore our laboratory has successfully completed this EGFET apparatus. To add to the strength of this new invention, it has very low light sensitivity and a linear, adjustable temperature coefficient.

### OBJECTIVE

This invention most importantly illustrates the method and apparatus of a non-insulated solid-state inorganic ion sensitive film as a potential, electrochemical ion sensitive electrode. This invention stresses the development of an EGFET biosensor with non-insulation ion sensitive materials such as tin oxide, ITO, titanium nitride, and IrO₂.

### ILLUSTRATIONS

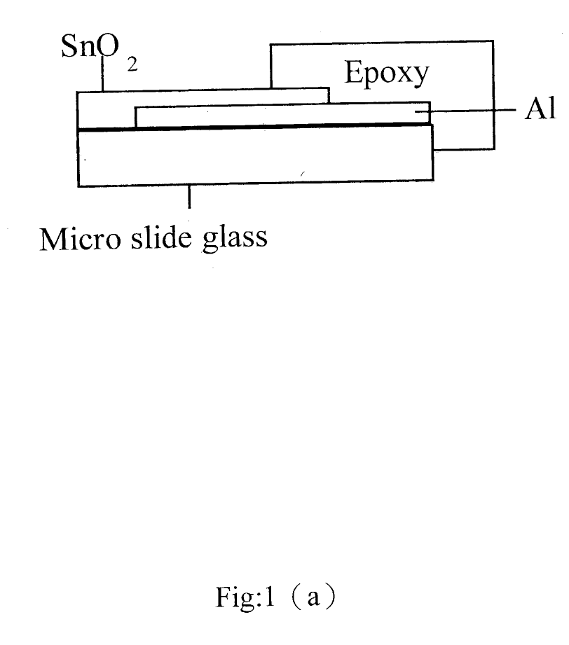

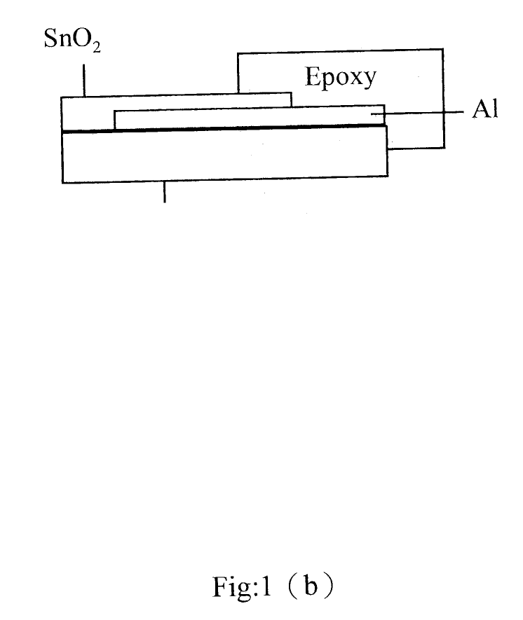

FIG. 1. Sectional View of Types of Solid State Ion Sensitive Electrodes.

(a) Micro Slide Glass as Sensor Substrate.

(b) Corning Glass as Sensor Substrate.

(c) ITO as Sensor Substrate.

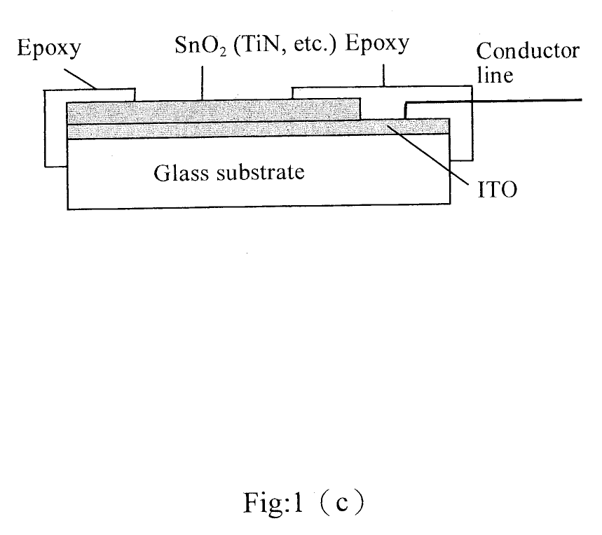

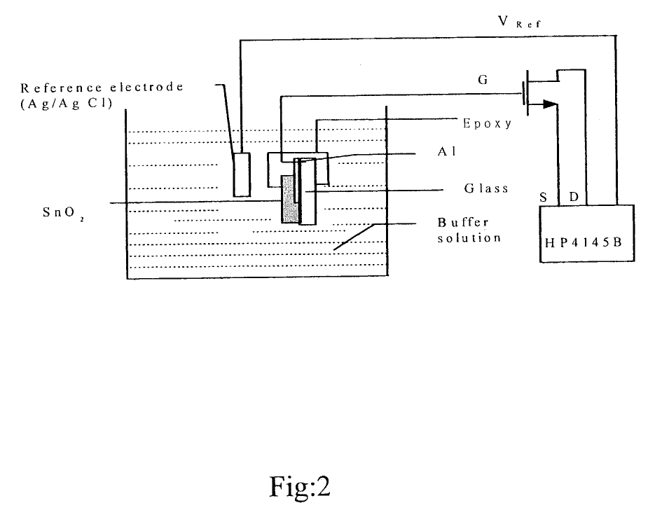

FIG. 2. Measuring Apparatus of Sensor Electrode of I-V Properties.

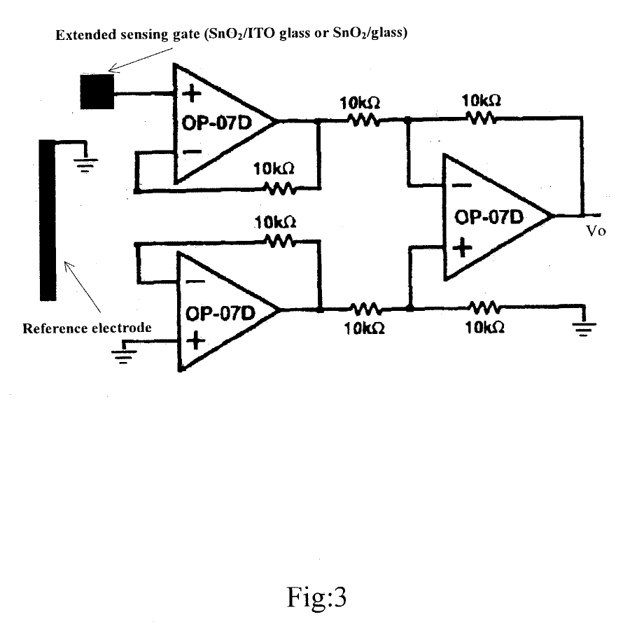

FIG. 3. Measuring Apparatus of Ion Sensitive Electrode.

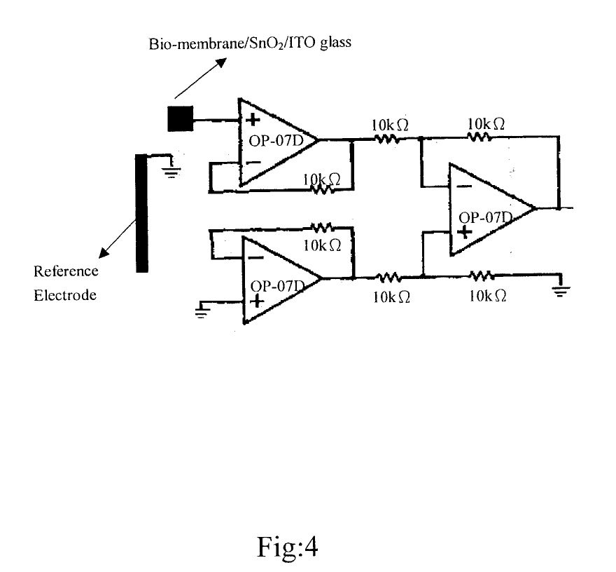

FIG. 4. Measuring Apparatus of Biosensor.

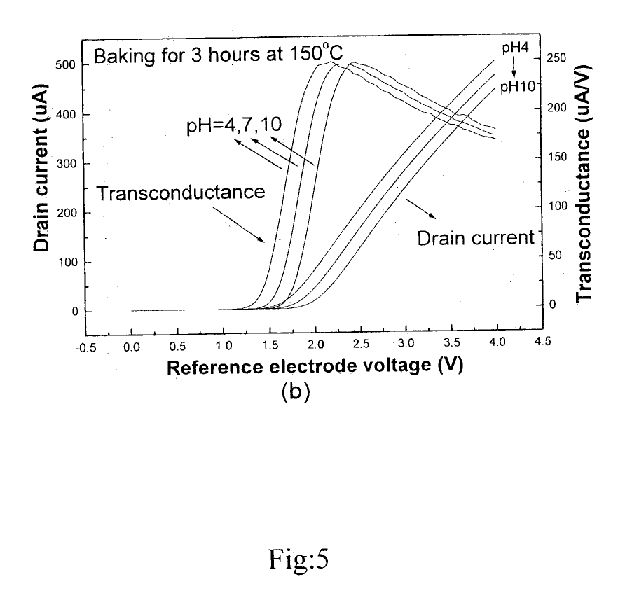

FIG. 5. I-V Properties of pH Sensor with Micro Glass Base.

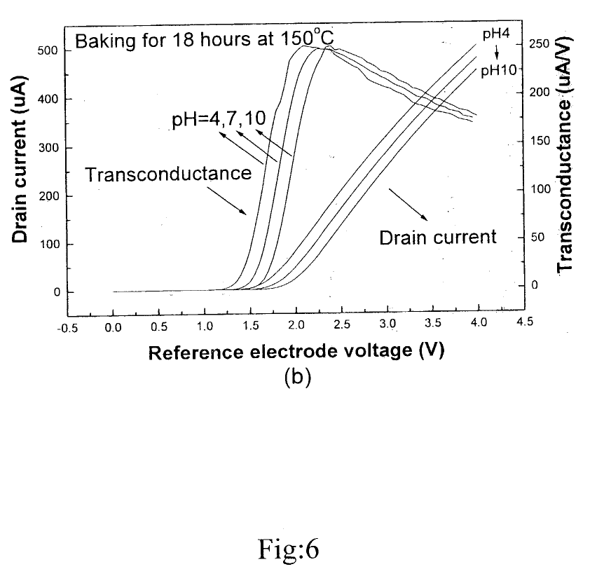

FIG. 6. I-V Properties of pH Sensor with Corning Glass Base.

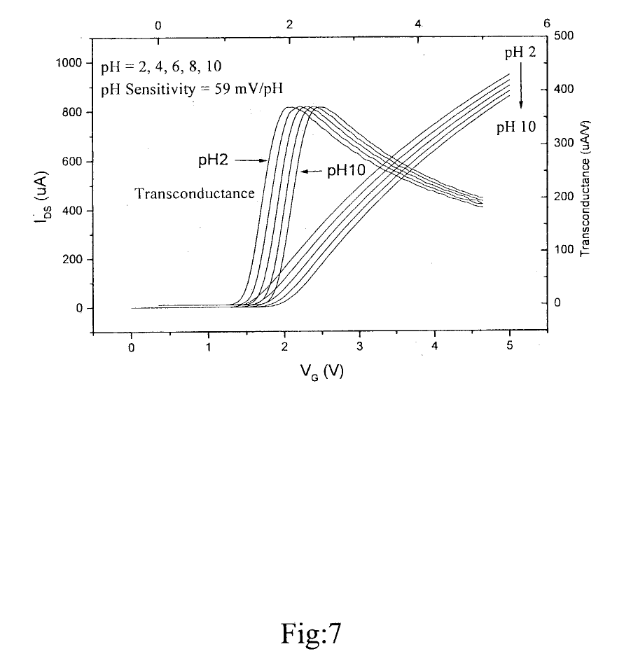

FIG. 7. (SnO₂/ITO glass) I-V Properties of pH Sensitive Electrode.

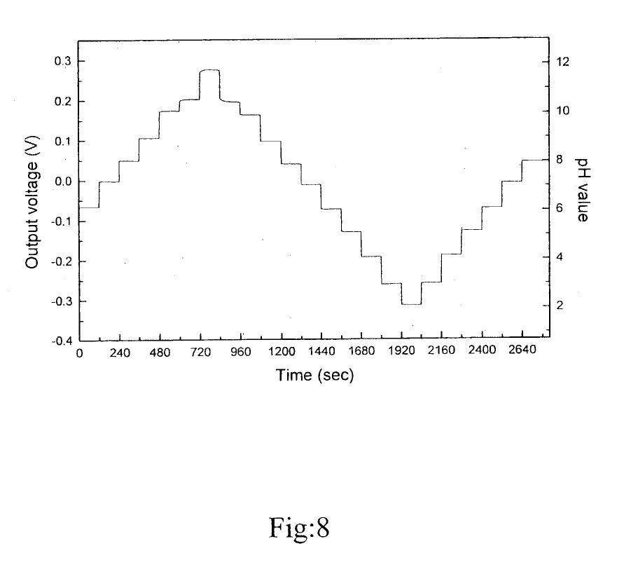

FIG. 8. (SnO₂/ITO glass) Properties of pH Sensitive Electrode.

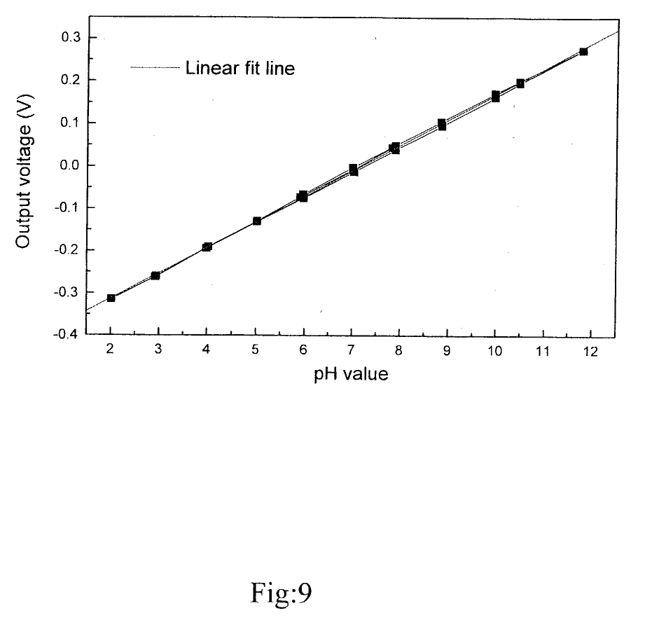

FIG. 9. (SnO₂/ITO glass) Output Corrected Curve of Sensitive Electrode.

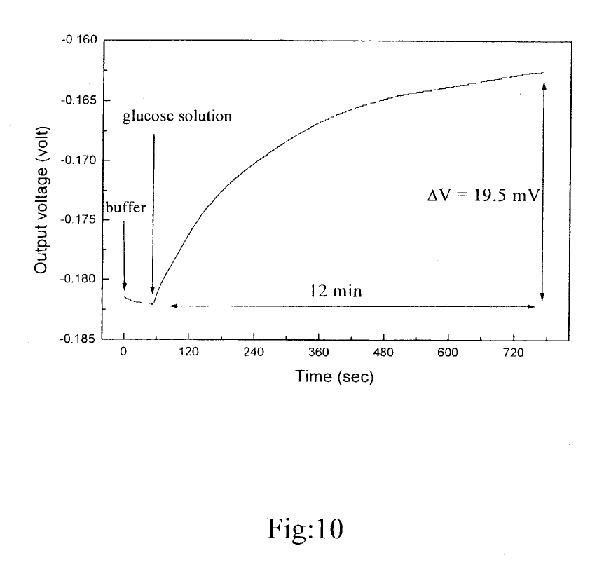

FIG. 10. Output Curve of Glucose Biosensor.

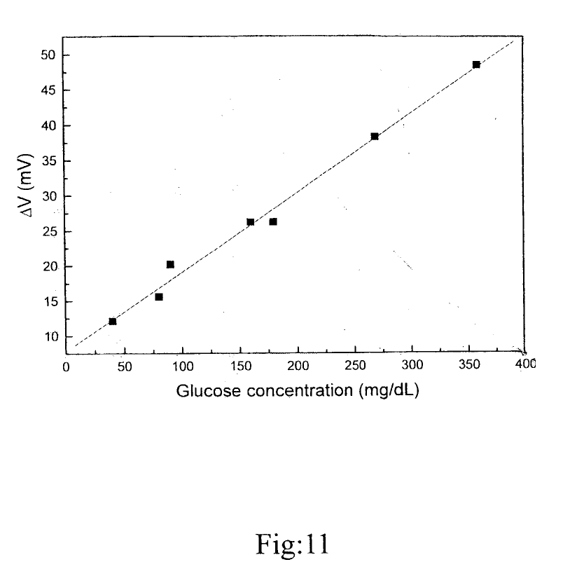

FIG. 11. Corrected Output Curve of Glucose Biosensor.

### FIGURE DESCRIPTION

1 . . . SnO₂ (TiN,etc.)

2 . . . Epoxy

3 . . . Al

4 . . . Micro slide glass

5 . . . Corning 7059 glass

6 . . . Conductor line

7 . . . ITO

8 . . . Glass substrate

21 . . . Reference electrode, Ag/Ag Cl

22 . . . Buffer solution

23 . . . HP4145B

25 . . . Reference electrode

26 . . . Extended sensing gate (SnO₂/ITO glass or SnO₂/glass

27 . . . Bio-membrane/SnO₂/ITO/glass

31 . . . Transconductance

32 . . . pH=4

33 . . . Drain current

34 . . . pH=7

35 . . . pH=10

36 . . . pH=2

37 . . . pH4→pH10

38 . . . pH2→pH10

51 . . . Linear line

52 . . . Glucose solution

53 . . . 12 minutes

54 . . . Voltage Difference=19.5 mV

### DETAILED DESCRIPTION

In this invention, an electrochemical potentiometric sensor and a biosensor, based on a non-insulated solid-state material, are presented. Electrochemical potentiometric sensors and biosensors with this base are different from the traditional ion sensitive field effect transistor (ISFET), in that the sensing electrode of the new invention is separated from the field effect transistor, connecting to the field effect transistor by a mere conductor line. Therefore the sensing electrode can be seen as a low cost, disposable electrode. Moreover, the structure of its sensitive electrode is stronger than the commercial glass electrode. Cost of the sensor is also lower than those of the traditional ion sensitive field effect transistor and glass electrode.

The abovementioned electrochemical potentiometric ion sensor made by uninsulated solid-state materials is unique in that an uninsulated solid-state ion sensor membrane (such as tin oxide) is deposited on the insulated or uninsulated substrate. A solid-state ion sensitive electrode is then formed to detect pH value of test solution. Conductor line is used as a message conductor, and wrapping materials such as epoxy is used to coat the non-sensitive areas. Sensitive area defined by the technology is about 3×3 mm². The conductor line is connected to readout circuit of high input impedance, such as MOSFET and operation amplifier, to form the structure of the ion sensor. The advantage of this sensor over ordinary ISFET and glass electrodes are in that this new sensor is microlizable, easy to produce, low-cost, dry-storable, has low light interference, easy to pack, adjustable sensitive area, and convenient to deliver

Moreover, this sensor has excellent characteristics; Nernst Effect is attained within pH2 to pH12. In the range of 58˜60 mV/pH, the relative coefficient of linear regression is over 0.999. Thus the sensitive linearity is excellent. And the sensitivity to light is minimal. Therefore this invention is highly feasible in the application of electrochemical potentiometric sensors and biosensors.

This sensor is capable of transforming into an electrochemical potentiometric biosensor by immobilizing biochemical such as enzymes, immune substances, and nucleic acids. This effectively solves the problems of size and cost of the large photo-bio analyzers. The new sensor is suitable for portable, immediate detection and is disposable. The sensitive membrane of this ion sensor can be composed of tin oxide, titanium nitride, ITO, or IrO₂; it can also be used to detect hydrogen concentration. The solid sensitive membrane can be chosen based on the range and characteristics of the particular purpose. The insulation substrate of the structure and sensitive membrane may be comprised of silicon, glass, porcelain, or polymers. Therefore, this sensor has a better flexibility in the substrates and can be adjusted according to the practical needs and process conditions.

### OPTIMUM EXAMPLE

A. Processing Conditions:

This electrochemical ion sensitive electrode utilizes semiconductor membrane plating technology to deposit a solid sensitive membrane on the substrate. For bio-electrodes, a bio-enzyme is immobilized on the solid sensitive membrane. The processing flow is as illustrated below:

1. Prepare a variety of substrates (insulation material substrates, conductive substrates etc.). The selection of substrate is based on the solid sensitive material and the environment of detection.

2. Clean the substrate board.

3. Deposit the solid-state sensitive material onto the substrate board (such as tin oxide or titanium nitride).

4. Wiring.

5. Seal with epoxy and secure the area of the sensitive window.

6. Immobilizing the enzyme membrane onto the solid materials.

Steps 1 to 5 applies to potentiometric ion sensitive processing; steps 1 to 6 applies to biosensor processing.

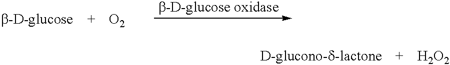

Glucose is broken down into D-glucono-δ-lactone and H₂O₂ with β-D-glucose oxidase catalysis.

D-glucono-δ-lactone→D-gluconate+H⁺

Through hydrolysis, H⁺ is produced. EGFET can detect changes in H⁺. Thus, concentrations of glucose or other substances can be detected by fastening the enzyme on the sensitive membrane of the extended ion sensitive field effect transistor.

3. Details on immobilizing enzymes, immune substances and nucleic acids (refer to line 11 of page 24 in the Invention Guide).

Covalent coupling method, gel entrapment method, etc. can be used to immobilize enzymes, immune molecules and nucleic acids. Use β-D-glucose oxidase as an example:

Entrapment

1. Weigh out 5 mg of β-D-glucose oxidase and 50 mg of polyvinylalchol bearing styrylpyridinium groups, PVA-SbQ. Place in 100 μl of sulfuric acid buffer.

2. Drop 1 μl of the enzyme mix onto EGFET (SnO₂/ITO). Let dry for 5 minutes.

3. Expose under UV ray for 20 minutes for light polymerization.

4. Place under 4° C., let dry and stable for 4 hours.

5. Immerse in D.I. water for 1 hour to wash away unattached enzyme.

6. Immerse in sulfuric buffer for 1 hour (5 mM,pH 8.08).

In steps 2, 3 and 5˜7 of the entrapment method, no exposure to the white light should be allowed. This is to prevent light induced polymerization of the enzyme.

B. Properties and Effects:

Shown in FIG. 1 is the Sectional Views of Solid State Ion Sensitive Electrodes. The pH value of a solution can be detected. The sensor substrate may be non-insulation glass, conductive glass, and other types of solid substrates. Shown in FIG. 2 is the Measuring figure of the I-V properties of this sensor. Using this measure, properties of the solid membrane can be analyzed and the pH sensitive property of the sensor can be confirmed.

FIG. 3 shows the utilization of the rear readout circuit to detect the voltage message for the analysis of acidity sensing message. FIG. 4 shows the utilization of the rear readout circuit to attain the sensor voltage message of the bio-sensing electrode.

FIG. 5 shows the process of depositing sensitive thin film on to a micro glass slide, and placing the sensor element under 150° C. for 3 hours. This stabilizes the sensor and this sensor possesses acid sensitivity. FIG. 6 shows he process of depositing sensitive thin film on to a coming glass slide, and placing the sensor element under 150° C. for 18 hours. This stabilizes the sensor and this sensor possesses pH sensitivity. From FIGS. 5 and 6, it is discovered that sensor elements with the conductive metal—Aluminum, is capable of improving the stability after a 3-18 hour temperature treatment of 150° C.

Shown in FIG. 7 is the deposition of tin oxide, solid thin film deposited on a ITO glass. Good pH sensitivity is already in place without temperature treatment. Shown in FIG. 8 is the transformation to voltage message using rear readout circuit. Tin oxide/ITO glass sensor generates different voltage message as the pH changes. FIG. 9 shows the linear output of the Tin oxide/ITO glass sensor. Combining FIGS. 7, 8 and 9, it is noted that between pH2 and pH 12, the Tin oxide/ITO glass sensor has a high sensitivity of 59.9 mV/pH, and the linear regression coefficient is over 0.999, an excellent linearity.

As shown in FIG. 10, the biosensor with an enzymatic thin film is placed into glucose solution. H⁺ is produced by the enzymatic reaction, and thus resulting in a voltage change. This method can be used to detect different glucose concentrations. As shown in FIG. 11, glucose solutions of different concentrations have a linear voltage output property. Therefore this bio-sensing element has can be used to detect glucose concentration and may be used to further research on biosensors.

Points of Patent Application

1) An apparatus with non-insulation, solid-state material as an electrochemical potentiometric ion sensor. It is unique in the deposition of an uninsulative, solid ion sensitive membrane (such as tin oxide) on the insulation substrate or non-insulation substrate. A solid-state ion sensitive electrode is formed to detect the acidity of the solution. Conductive wires are used as message conductors. The non-sensitive areas are coated with wrappers such as epoxy. The sensitive area defined by the technology. The metallic wire is connected to a readout circuit of high input impedance, such as MOSFET and operation amplifier, to form the structure of the ion sensor.

2) Apparatus described by (1), immobilizing with biochemical substances such as enzymes, immune molecules, and nucleic acids on the ion sensitive electrode. This forms an electrochemical potentiometric biosensor, which can solve the problems of size and cost of the large photo-bio analyzers. The new sensor can be produced as suitable for portable, immediate detection and is disposable.

3) Apparatus described by (1), the insulation substrate board can be comprised of tin oxide, ITO, or IrO₂.

4) Apparatus described by (1), can be used to detect hydrogen concentration. The selection of the solid sensitive membrane can vary based on the usage and characteristics of the object:

5) Apparatus described by (1), the structure and the insulated substrate board of this ion sensitive element can be comprised of silicon, glass, porcelain, or other polymers.
